(19) United States
(12) Patent Application Publication
(10) Pub. No.: US 2026/0164209 A1
(43) Pub. Date: Jun. 11, 2026

(54) Method and System for Interactive Video and Spatial Audio Presentation

(71) Applicant: Holography Inc., Alameda, CA (US)

(72) Inventors: Brian Baumbusch, Alameda, CA (US); Colin Cody-Waters, Cosa Mesa, CA (US)

(21) Appl. No.: 19/462,558

(22) Filed: Jan. 28, 2026

Related U.S. Application Data
(63) Continuation-in-part of application No. 18/811,621, filed on Aug. 21, 2024.
(60) Provisional application No. 63/880,819, filed on Sep. 12, 2025.
(60) Provisional application No. 63/603,866, filed on Nov. 29, 2023.

(51) Int. Cl. H04S 7/00; G06T 13/40

(52) U.S. Cl. CPC H04S 7/303; G06T 13/40; H04S 2400/11

(57) ABSTRACT

To present an audio-visual experience, a system will identify audio sources and, for each of the audio sources, a position of the audio source in a virtual environment. For each of the audio sources, the system will identify an audio track. A user interface of an electronic device will receive a location of an avatar in the virtual environment. For one or more of the audio tracks, the system will determine an enhancement level or an attenuation level for the audio track based on the distance and/or orientation of the avatar to the audio source in the virtual environment. The system will apply, to each audio track, its determined enhancement level or attenuation level. An audio output will concurrently output each of the audio tracks with its applied enhancement level or attenuation level.

### RELATED APPLICATIONS AND CLAIM OF PRIORITY

This patent document claims priority to U.S. provisional patent application number 63/880,819, filed September 12, 2025. This patent document also claims priority as a continuation-in-part to U.S. patent application number 18/811,621, filed August 21, 2024, which claims priority to U.S. provisional patent application number 63/603,866, filed November 29, 2023. The disclosures of all priority applications are incorporated into this document by reference.

### BACKGROUND

The evolution of mobile electronic devices has dramatically transformed the way individuals consume audio-visual content. As smartphones and tablet computing devices have become ubiquitous, and as augmented reality and virtual reality devices have become more frequently adopted, users increasingly rely on these devices for a diverse range of multimedia experiences, including streaming audio content, videos, and engaging in various entertainment experiences.

Despite significant advancements, there remain inherent limitations in the current technology for presenting audio-visual format in digital devices that necessitate further improvements to engage users and enhance user experiences. For example, the built-in speakers of mobile devices often lack the depth and richness required for an immersive audio experience. External headphones and speakers can mitigate this issue, but they are still limited by the bandwidth and other technical constraints of the particular communication technology that the device uses.

This document describes methods and systems that address some or all of the issues described above.

### SUMMARY

Systems and methods for generating and presenting an audio-visual experience are disclosed. A processor executes programming instructions that will cause the processor to identify a plurality of audio sources and, for each of the audio sources, a position of the audio source in a virtual environment. For each of the plurality of audio sources, the processor will identify an audio track for the audio source. The processor will receive, via a user interface of an electronic device, a position of an avatar in the virtual environment. For one or more of the audio tracks, the processor will determine an enhancement level or an attenuation level for the audio track based on the distance of the avatar to the audio source in the virtual environment.

Optionally, the processor also (or alternatively) may receive an orientation of the avatar in the virtual environment. If so, then when determining the enhancement level or the attenuation level for the audio track, the processor also may do so based on the orientation of the avatar with respect to the audio source in the virtual environment.

The processor will apply, to each of the one or more of the audio tracks, its determined enhancement level or attenuation level. The processor will then cause an audio output of an electronic device to concurrently output each of the audio tracks with its applied enhancement level or attenuation level.

### BRIEF DESCRIPTION OF THE DRAWINGS

FIG. 1 is a diagram illustrating example elements of a spatial audio presentation system, and methods of using them.

FIGS. 2A-C illustrates an example virtual audio-visual experience that may be presented to a user on a display of an electronic device.

FIG. 3 illustrates a virtual environment that is displayed as a two-dimensional plane with various virtual audio sources.

FIGS. 4A and 4B illustrate the virtual environment of FIG. 3 with spatial audio zones corresponding to each audio source.

FIG. 5 illustrates an alternate virtual environment that is displayed as a two-dimensional plane with various virtual audio sources.

FIG. 6 illustrates an alternate virtual environment that is displayed as a two-dimensional plane with various virtual audio sources, with graphic enhancement generated and displayed as an avatar moves into an audio zone associated with a particular audio source.

FIG. 7 illustrates various elements of a spatial audio presentation system in block diagram format.

FIG. 8 illustrates an example attenuation curve that the system may use.

FIG. 9 illustrates an example user interface for controlling attenuation.

FIG. 10 illustrates a process of causing an electronic device to output an audio representation of spatial audio.

FIGS. 11A-11C illustrate additional features that the described processes may offer, including shadows and use of a virtual audio plane.

FIGS. 12A-B illustrate an example process of rendering an avatar on a display.

FIG. 13 illustrates example components of an electronic device.

### DETAILED DESCRIPTION

In this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.”

When used in this document, the term “exemplary” is intended to mean “by way of example” and is not intended to indicate that a particular exemplary item is preferred or required.

Additional terms that are relevant to this disclosure will be defined at the end of this Detailed Description section.

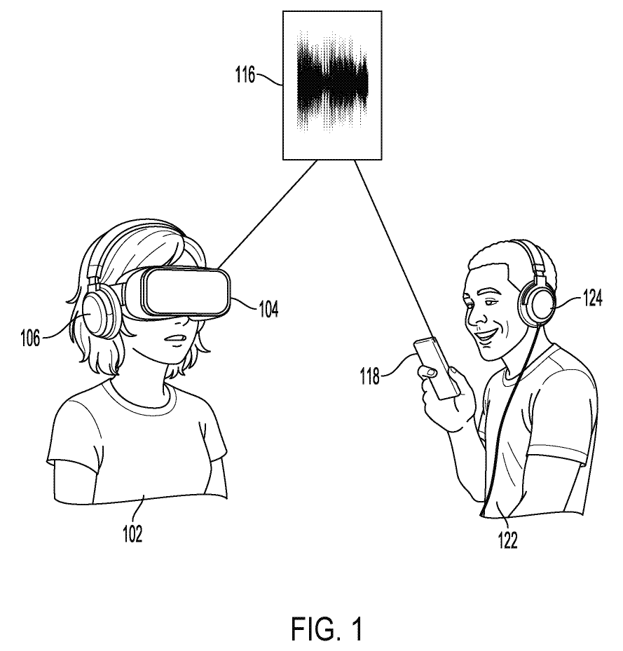

FIG. 1 is a diagram illustrating example elements of a spatial audio presentation system, and methods of using them. As shown in FIG. 1, in some implementations, a listener 102 uses an electronic device 118 such as a smartphone, tablet computer, laptop computer, or a television that is connected to a gaming platform to access the spatial audio animation system. In some implementations, the electronic device 118 by which a listener 122 may access the system may be, or may include, a virtual reality (VR) or augmented reality (AR) headset 104.

In each embodiment, the electronic device 118 will include a processor, a user interface, software and/or firmware, and an audio output to provide the listener with an audio-visual experience 116 by which the user views a virtual environment on a display device of the electronic device, such as a screen of a handheld electronic device 118 or a head-up display of a VR or AR headset 104, and the viewer hears sound associated with the virtual environment according through the audio output, such as through headphones 106 or 124 or speakers of the electronic device.

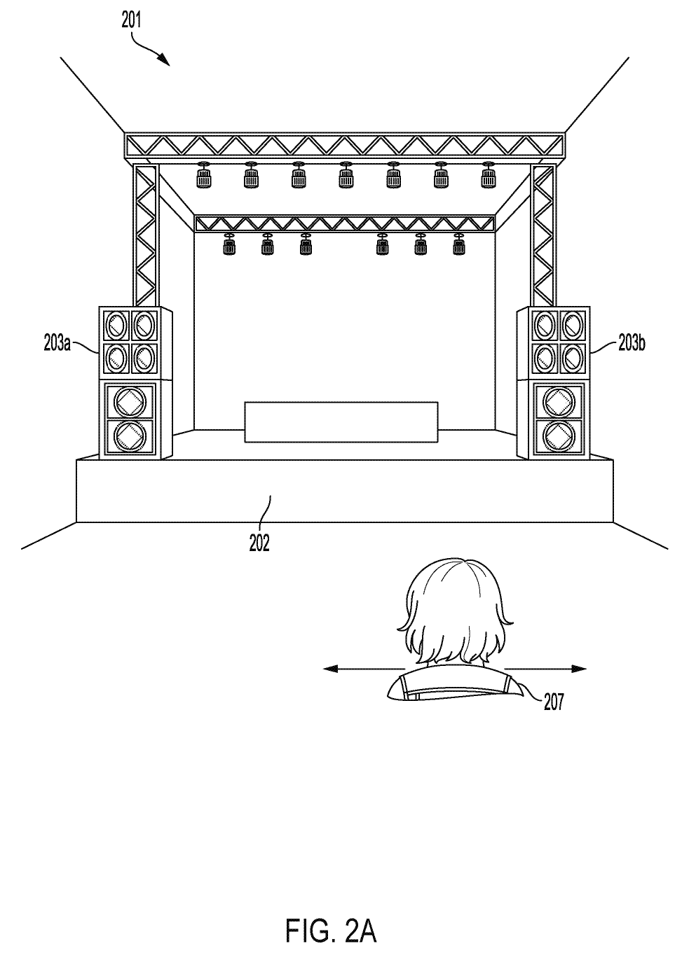

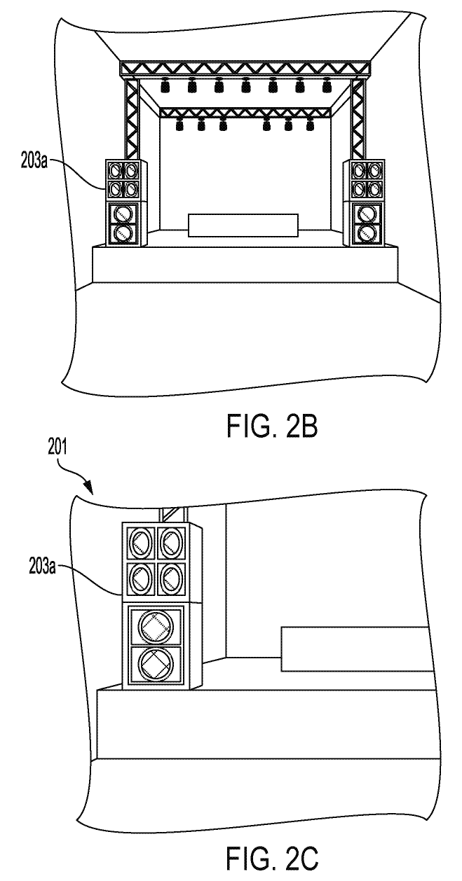

In some embodiments, the audio-visual experience 116 may be an expression of music-based spatial audio animation, wherein sound sources or "speakers" are positioned around a virtual space (e.g. a 2D or 3D environment), each carrying its own discrete audio signal. An example of such an experience, as it may appear on a display, is illustrated in FIGS. 2A-C. FIG. 2A illustrates an example of a virtual environment 201 that illustrates a stage 202 and various audio sources 203A, 203B (in this case, speakers) positioned at various locations in the virtual environment 201. The virtual environment may be shown from the point of view of an avatar 207 that appears in the foreground of the image, and which may be moved to various locations in x-y-z coordinates in the virtual environment. Alternatively, as illustrated in FIG. 2B, the avatar may not be displayed but instead may be a virtual avatar, and the appearance of the virtual environment 201 may move (such as by sliding right to left or left to right, or up or down, or by zooming on or out, or any combination of these), as the user moves the virtual avatar in the environment. An example of such a zoomed-in first person view of the virtual environment 201 is illustrated in FIG. 2C.

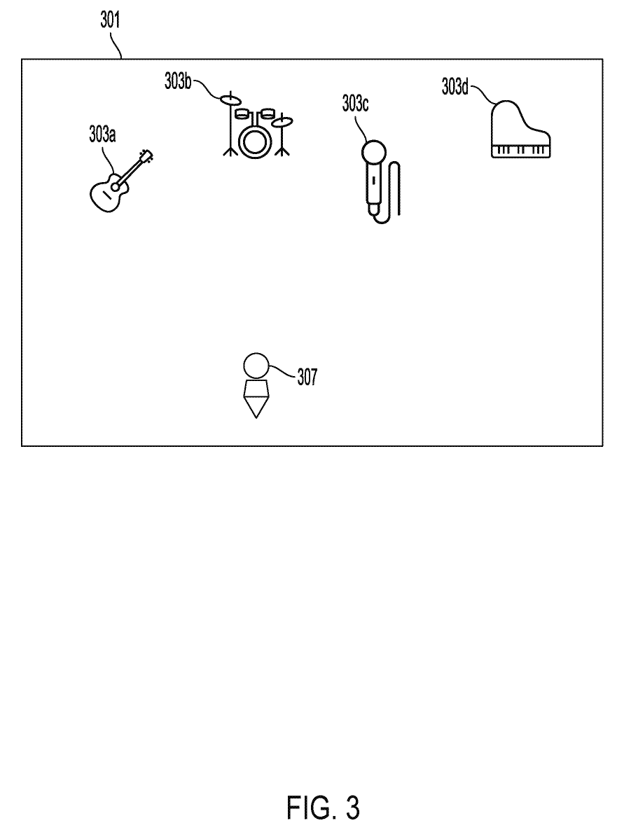

Other embodiments of the virtual environment are possible. For example, as shown in FIG. 3, a virtual environment 301 may simply be a displayed as a two-dimensional plane in which any number of virtual audio sources 303a … 303d are positioned at various locations in the environment. In this example, each audio source is a different instrument (guitar 303a, drums 303b, microphone/vocalist 303c, and keyboard 303d). An avatar 307 is positioned anywhere in the environment 301 and may be moved about the environment via a user interface such as touchscreen, trackpad, keypad, joystick, a gesture recognition interface, or the like. The audio sources 303a … 303d and avatar 307 may or may not be output as visible on the display. The movement of the avatar 307 in the virtual environment may be made in any direction along the x-axis, y-axis, and/or z axis of the virtual environment. Optionally, the orientation of the avatar also may be moved, so that the avatar may rotate or tilt in any direction (i.e., by changing the pitch, yaw, or roll of the 3D avatar body), in which case the system will allow the avatar to be moved with six degrees of freedom (6DOF).

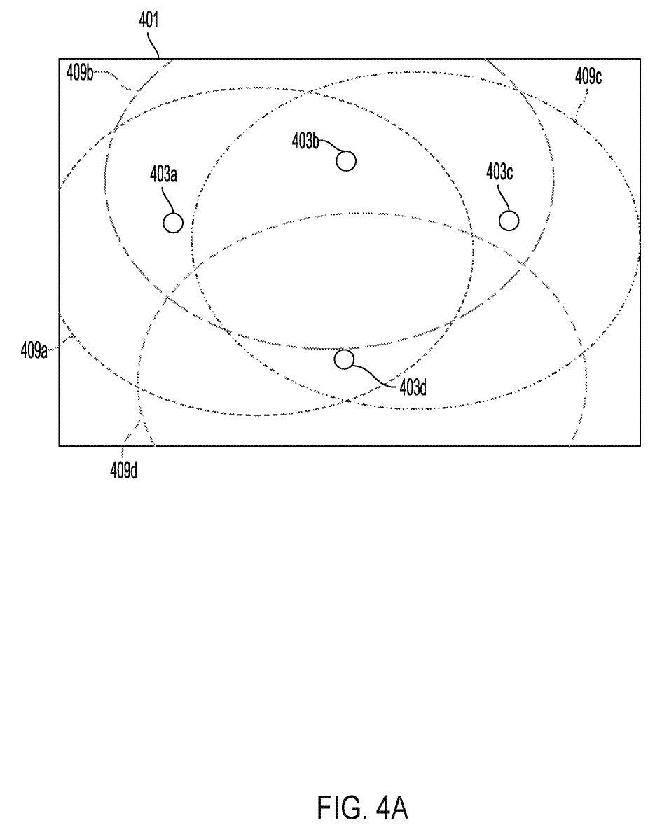

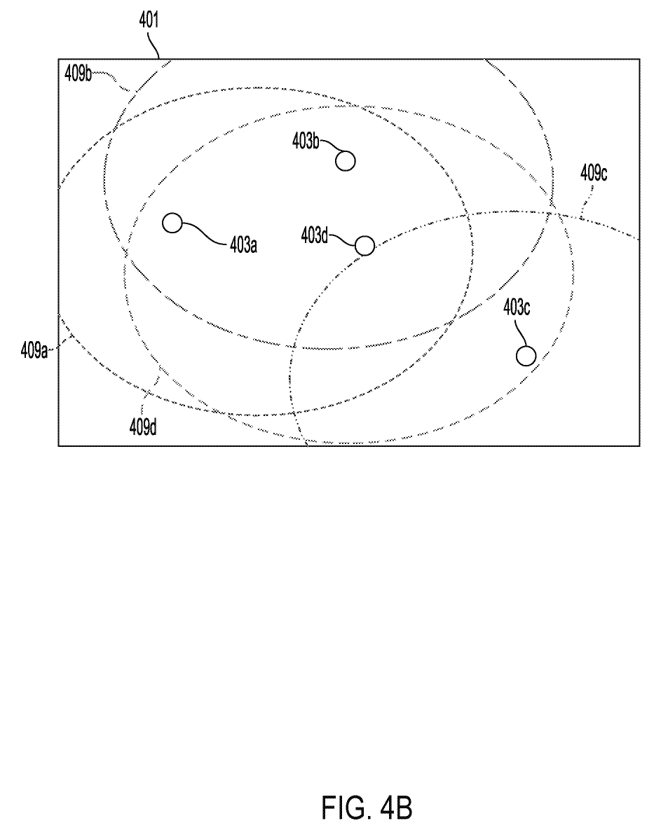

For each spatial audio source, the system will define a unique spatial audio zone to represent an area in the virtual environment in which sound that the audio source emits may be heard in the virtual environment. For example, referring to the virtual environment 401 of FIG. 4A, the first audio source 403a will emit sound that can be heard when the user’s avatar is positioned anywhere in the spatial audio zone that is within the area that is within the first zone boundary 409a. The second audio source 403b will emit sound that can be heard when the user’s avatar is positioned anywhere in the spatial audio zone that is within the area bounded by second zone boundary 409b. The third audio source 403c will emit sound that can be heard when the user’s avatar is positioned anywhere in the spatial audio zone that is within the third zone boundary 409c, and the fourth audio source 403d will emit sound that can be heard when the user’s avatar is positioned anywhere in the spatial audio zone that is within the zone that is within the fourth zone boundary 409d. Characteristics of audio emitted by that zone’s audio source may vary as the avatar moves to different locations in the zone. For example, the volume of that source’s audio may increase as the avatar moves closer to the audio source’s origin point (i.e., the location of the audio source in the zone). The volume may decrease as the avatar moves away from the audio source’s origin point.

As shown, some or all of the boundaries of the spatial audio zones may partially overlap. When the avatar is positioned in areas of the virtual environment 401 where boundaries overlap, the system will generate and emit sound for all of the audio sources for which corresponding spatial audio zones include that area.

Optionally, the system may enable individual audio sources to be moved to a new position in the virtual environment. When an audio source is moved to a new location, the system will dynamically update the definition of that audio source’s spatial audio zone to correspond to the new location of the audio source. This is shown in FIG. 4B, in which the locations of audio sources 403c and 403d have moved when compared to their locations in FIG. 4A. and the locations of those audio sources’ spatial audio zones 409c, 409d have also moved to corresponding new locations.

Note that FIGS. 4A and 4B show each zone as being elliptical in shape. However, other shapes are possible, such as circles, cones, triangles, and/or other shapes.

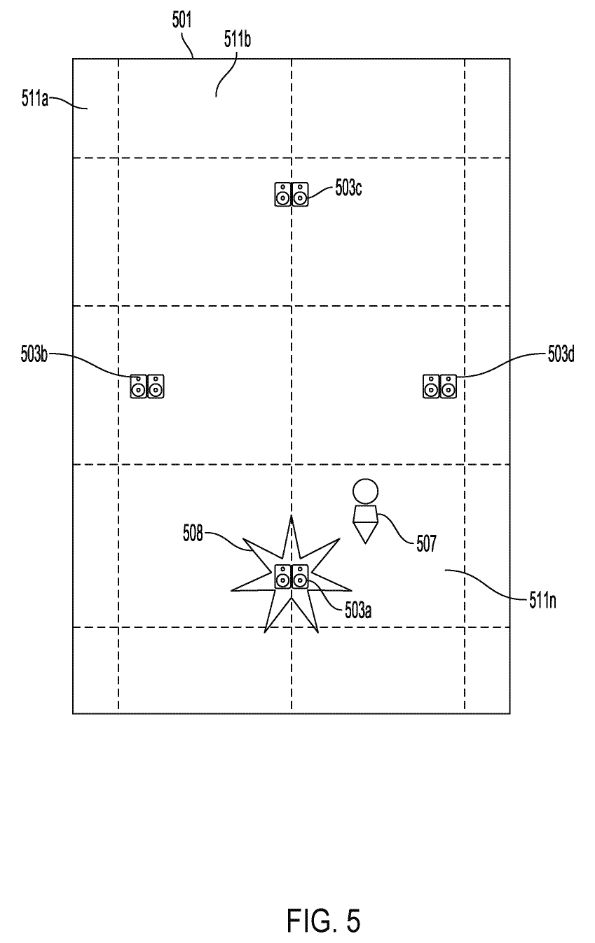

FIG. 5 illustrates another embodiment of an audio-visual experience in which various audio sources 503a ... 503d are shown on a display device positioned at various locations in a virtual environment 501. The virtual environment is divided into any number of regions 511a … 511n, each of which is a unique spatial audio zone (referred to here generally as 511). As the user interface of the electronic device is operated to move the avatar 507 throughout the virtual environment, the avatar may move among the various audio zones. Each audio zone 511 is a region in the virtual environment for which the system will output audio for the associated audio source when the avatar is positioned in that audio zone. Thus, movement of the avatar 507 through the audio zones 511 will result in the system outputting a unique audio-visual experience to the user.

For example, when the avatar is positioned in zone 511n, the avatar is nearest to audio source 503a, so the system may generate a mix of music from all of the audio sources in which the volume (i.e., amplitude) of audio emitted by audio source 503a is louder than the volume (amplitude) of audio emitted by the other audio sources 503b … 503d. In addition, the system may enhance the displayed representation of the nearest audio source (in this case audio source 503a) with a graphic enhancement 508 so that the nearest audio source 503a differs from the displayed representation of the other audio sources 503b … 503d. The applied graphic enhancement 508 may be, for example, causing the nearest audio source 503a to appear larger, brighter, with an outline, or surrounded by an additional graphic such as a circle, oval, star, or cloud.

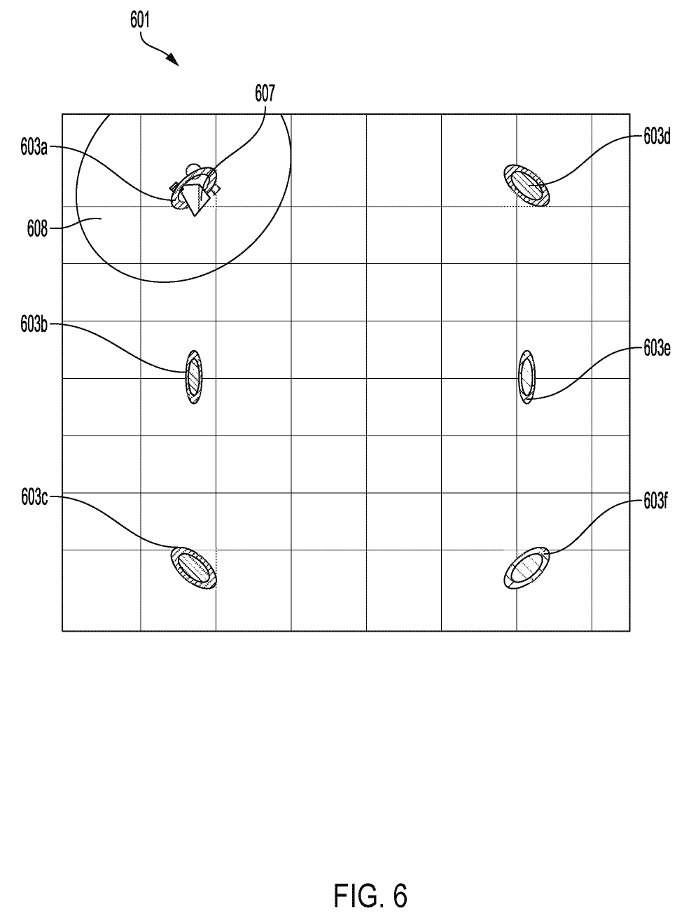

FIG. 6 illustrates another example of a virtual environment 601 that includes six audio sources 603a … 603f, each of which is associated with a spatial audio zone. Each audio source will be positioned in a zone associated with sound emitted by that audio source. When the avatar 607 is moved a position that is proximate to (i.e., within a threshold distance from) or touches an audio source 603a, a graphic enhancement 608 will be generated and displayed with that audio source 603a.

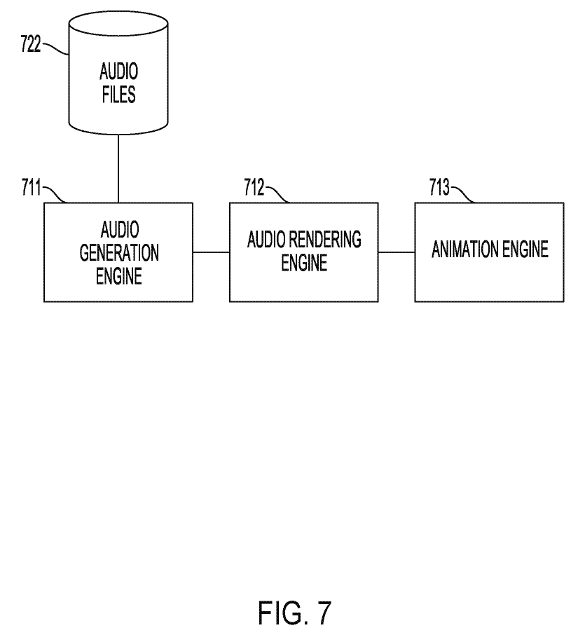

FIG. 7 illustrates various elements of the software that will operate the system. Each “engine” described in FIG. 7 will include a set of programming instructions, stored in a memory, optionally with access to reference data such as stored audio files. The instructions are configured to cause the processor to perform various steps, which will be described below. The engines may be part of a single software program, or they may be separate software programs that operate together to perform various functions. In operation, an audio generation engine 711 of the system will generate and/or identify output audio tracks for each audio source that is present in the virtual environment. The audio tracks may be pre-recorded, generated based on a predetermined pattern of notes, and available to be retrieved from in a data store of audio files 722. Alternatively, or in addition, the audio generation engine 711 may generate a unique audio track for each audio source in real time using a random audio generator, a trained machine learning (ML) model that can generate sounds, or by other methods. Audio content that may be stored or generated can include audio in the form of .WAV files .MP3 files, MIDI assets in the form of .mid files, or digital audio in any other format.

The audio tracks created or selected by the audio generation engine 711 are provided to an audio rendering engine 712 which can be implemented using any variety of known techniques, and which produces signals for generating audio that can be output through an audio interface of an electronic device. In doing so, audio rendering engine 712 can apply appropriate spatial audio processing to impart spatial aspects to the sound perceived by the listener from each of the audio sources that are positioned in the virtual environment. For example, a stereo output may include left and right channel signals, with the left channel signal delivered to a headphone or speaker that is intended to be positioned relatively nearer to the user’s left ear, and the right channel signal delivered to a headphone or speaker that is intended to be positioned relatively nearer to the user’s right ear.

As the user moves the avatar through the various zones of the environment, the system will generate a mix of the audio tracks from each audio source that corresponds to the relative distance from that zone to each audio source. For example, referring to FIG. 5, using a reference mix in which all audio sources are output at equal amplitude, when the avatar 507 is positioned in region (spatial audio zone) 511n, the system may increase the amplitude of the audio track for audio source 503a and attenuate the amplitude of the audio tracks for the other audio sources 503b … 503d because audio source 503a is positioned on the border of region 511n while all other audio sources 503b … 503d are positioned at various distances away from region 511n. In addition, the system may determine the attenuation to apply to each of the other audio sources 503b … 503d as a function of the other audio sources’ 503b … 503d distance from region 511n. for example, when the avatar 507 is positioned in region 511n of FIG. 5, the signal for audio source 503c may receive the most attenuation of the other audio sources because its position is the furthest distance from region 511n as compared to that of the other audio sources, while the signal for audio source 503a may receive the least attenuation of the other audio sources because its position is the closest distance from region 511n as compared to that of the other audio sources.

In addition, when the avatar is positioned in region 511n, audio sources 503a, 503b, and 503c are positioned to the left of the avatar in the virtual environment and thus may be rendered with an amplitude that is higher in the left channel(s) of the audio output than in the right channel of the audio output, while audio source 503d is positioned to the right of the avatar in the virtual environment and thus may be rendered with an amplitude that is higher in the right channel(s) of the audio output than in the left channel of the audio output.

Further, in embodiments that allow the avatar to be moved according to a 6DOF format, the system also may consider the rotational orientation of the avatar with respect to the audio source. For example, in FIG. 5 avatar 503 includes a head represented by a circle and a body represented by a pin shape. If the avatar is tilted or rotated so that its head moves toward a particular audio source, or so that its ears or other audio input elements are facing toward the audio source, then the amplitude of that audio source may be increased. If the avatar is titled or rotated so that its head moves away from a particular audio source, or so that its ears or other audio input elements are not facing toward the audio source, then the amplitude of that audio source may be decreased.

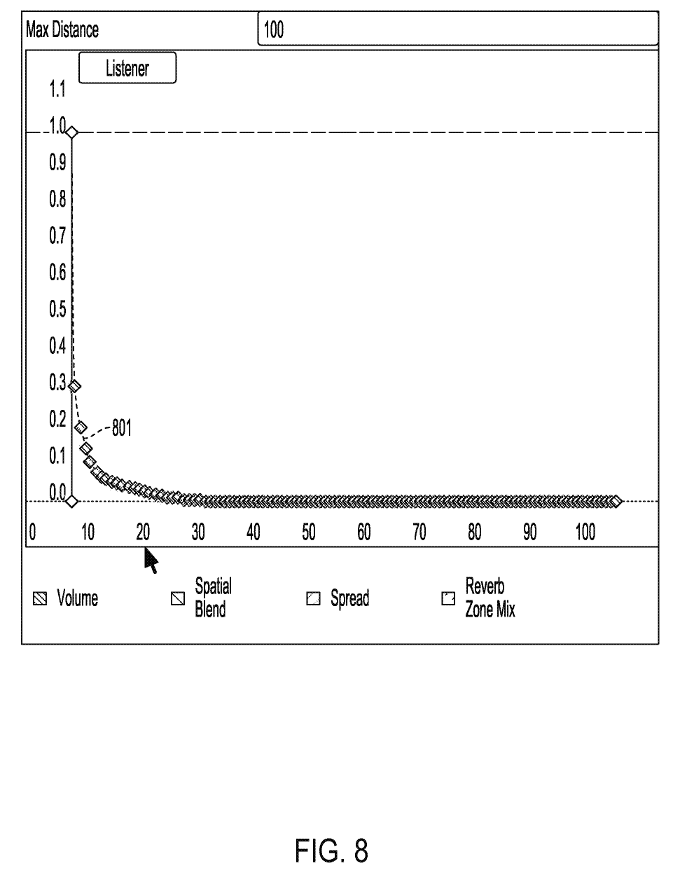

FIG. 8 illustrates how the system may apply attenuation to the sound emitted by each audio source as the user moves the avatar about the virtual environment. In this example, the system applies an attenuation curve 801 to the sound emitted by an audio source so that the volume of the sound is at its peak when the avatar is at the audio source (distance from source = 0), and the sound is reduced as the user moves the avatar away from the audio source. In the example shown, the volume of the sound is reduced to near zero when the user is approximately 30 units of measure away from the location of the audio source, and to zero when the user is approximately 100 units of measure away from the location of the audio source. (The units of measure may be any suitable unit, such as a number of pixels.) Other processes of attenuating the sound may be used. The system may blend sounds from multiple audio sources that are associated with a particular zone by using a spatial reverb process or other process.

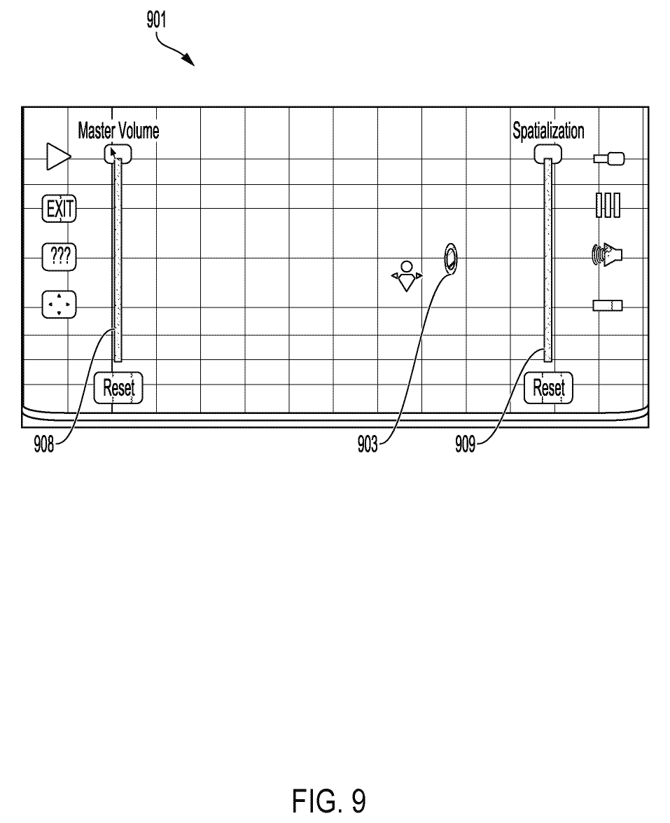

The system may use a common attenuation curve for all or some of the audio sources, or the system may use unique attenuation curves for one or more of the audio sources. In some embodiments, the system may offer the user the ability to adjust attenuation levels and other characteristics of the sound. FIG. 9 illustrates an example of such a user interface 901. The user interface 901 includes a master volume control 908, which in this case is a slidable bar, that enables the user to cause the system to apply a particular volume limit and/or attenuation curve to all audio sources. The user interface 901 also may include a spatialization control 909, which in this example is a slidable bar, that enables the user to adjust the shape of the distance attenuation curve as applied to all audio sources, where adjusting the slidable bar will cause the system to interpolate between a steep parabolic curve (when the bar is pulled up) with a steep curve resulting in significant distance attenuation applied based on the avatar's position relative to the audio sources, and a flat line (when the bar is pulled down) with a flat line resulting in no distance attenuation being applied between the audio sources and the avatar. If the system offers both a master volume control 908 and a spatialization control 909, the system will sum the values from these calculations when rendering final audio levels.

Returning to FIG. 7, as the avatar is moved through the virtual environment, an animation engine 613 may generate graphics in response to movement of the avatar in the virtual environment, and it may cause the graphics to be output on the display device. For example, as shown in FIG. 5, when the avatar 507 is closest to audio source 503a, the animation engine may generate and cause the display to output a graphic enhancement 508 to the displayed representation of audio source 503a. Another example is shown in FIG. 6, where the avatar 607 is positioned to contact audio source 603a, and the animation engine generates and causes the display to output a graphic enhancement 608 to the displayed representation of audio source 603a. In addition, or alternatively, the animation engine 713 may generate and display visual representations of sound waves, pulses, or other graphics that follow the avatar as it moves through the environment. The appearance of the visual representations may change as the volume, frequency, or other characteristics of the audio output changes.

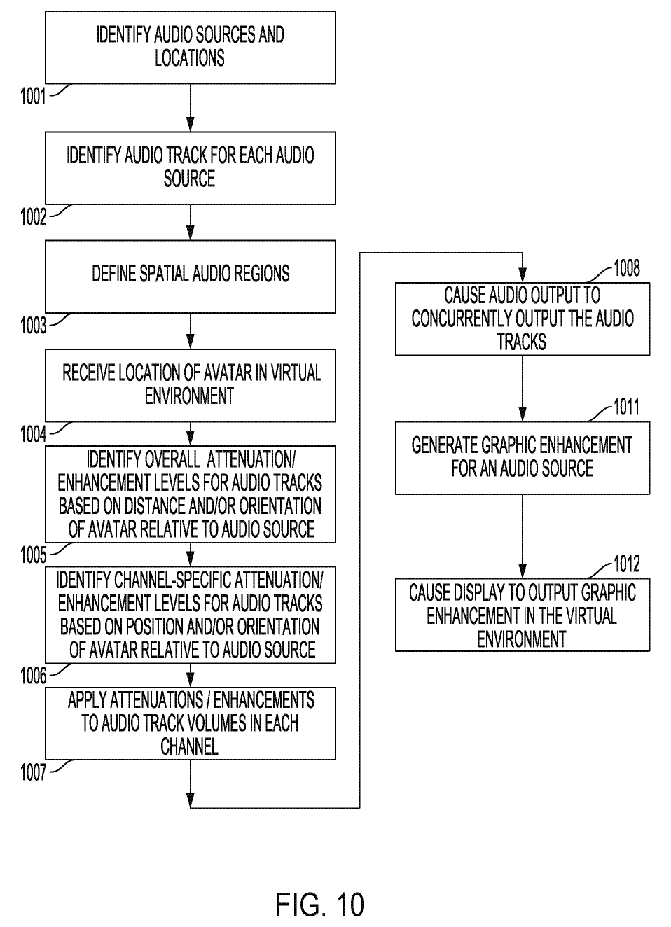

As the avatar is moved throughout the virtual environment, the characteristics of the audio and animations that the system will generate and output to the user in the audio-visual experience will change. This may be illustrated by the methods described above, which are also summarized in the flow diagram of FIG. 10. At 1001, the system will identify a set of audio sources and, for each of the audio sources, a position of the audio source in a virtual environment. For each of the audio sources, at 1003 the system will identify an audio track for the audio source using processes such as those described above.

As described above, in some embodiments at 1003 the system may define spatial audio regions for the virtual environment. For example, the system may simply partition the environment into regions as illustrated in FIG. 5, or it may define a unique spatial audio region for each audio source as illustrated in FIGS. 4A and 4B. Other methods of defining spatial audio regions are possible. If an audio source moves to a new location, at 1003 the definition of the spatial audio region for that audio source may be an update to a previous definition, as described above in the discussion of FIGS. 4A and 4B.

At 1004, the system will receive, via a user interface of an electronic device, a location of an avatar in the virtual environment. For example, as described above, a user may use a touchscreen, touch pad, a trackball or trackpad, gesture recognition technology, a joystick, an audio input, to move and position the avatar in the environment.

At 1005, the system will determine an overall enhancement level or an overall attenuation level for at least some of the audio tracks based on the distance of the avatar to the position of the audio source in the virtual environment. For example, the system may modify (or not modify) the volume of each audio track based on the relative distance between that audio track’s audio source and the avatar in the virtual environment using processes such as those described above. In addition, or alternatively, the system may modify (or not modify) the volume of each audio track based on rotational orientation of the avatar with respect to that audio track’s audio source in the virtual environment using processes such as those described above.

Optionally, at 1006, the system also may determine a channel-specific enhancement level or a channel-specific attenuation level for at least some of the audio tracks based on the relative position of the avatar to the position of the audio source in the virtual environment. For example, if a particular audio source is positioned to the left of the avatar on the display screen, the system may cause the volume of that audio source’s audio output by the left channel to increase, and/or cause the volume of the right channel audio output to decrease, so that the audio output by the left channel is greater than the volume of that audio source’s audio output by the right channel. Optionally, the system may apply different attenuation curves to the different sources in each channel.

At 1007 the system will apply the determined enhancement levels or attenuation levels to the audio tracks. At 1008 the system will cause an audio output of an electronic device to concurrently output each of the audio tracks with its applied enhancement level or attenuation level. Optionally, the system may apply additional audio enhancements to one or more of the audio tracks. For example, the system may generate and apply environmental effects, such as reverb or compression, to all of the tracks or one or more individual tracks.

Optionally, as the avatar moves in the virtual environment, at 1011 the system also may generate graphic enhancements for the virtual environment. Example methods of doing this are described above in the discussion of FIGS. 5 and 6. At 1012 the system may cause the display device to output the graphic enhancements to the displayed environment, such as by applying visual overlays, by modifying the appearance of audio sources, or by generating unique graphics.

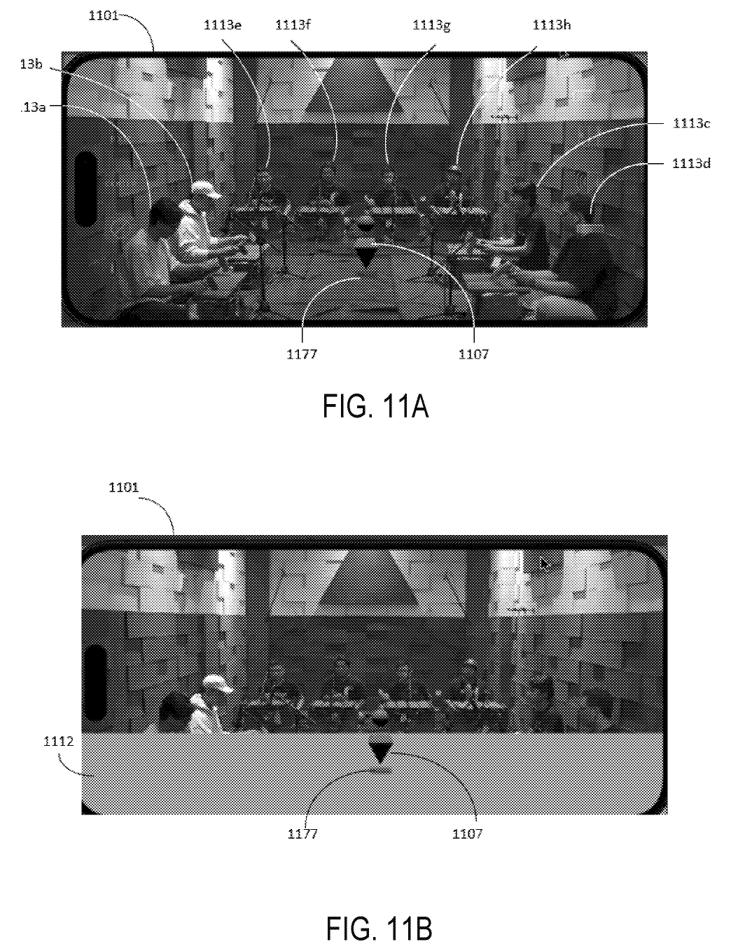

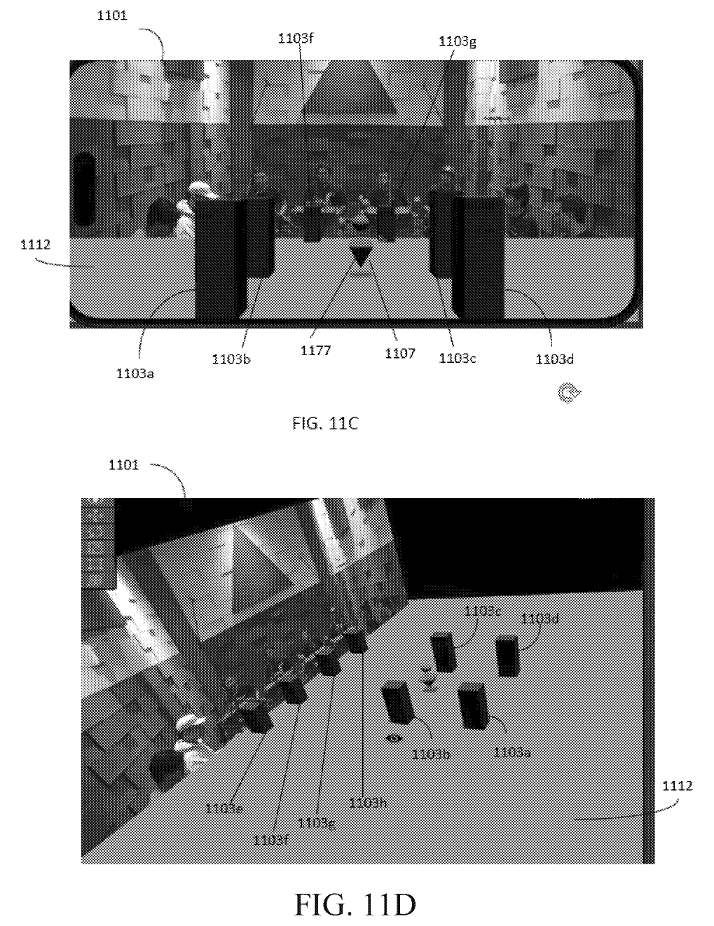

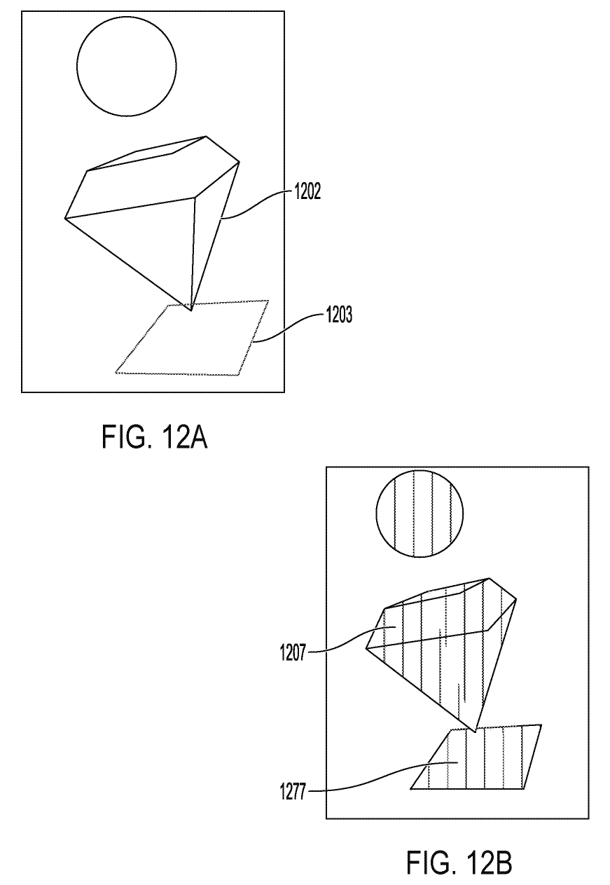

As described above, in various embodiments the system may generate and display a moveable avatar, and changes in audio effects, visual effects, or both may result as the user moves the avatar or audio sources about the environment. FIG. 11 illustrates another example image of a user interface 1101 that includes such an avatar 1107. In some embodiments, the system may generate a shadow 1177 for the avatar and cause the shadow 1177 to follow the avatar as the avatar 1107 moves through virtual environment, Referring to FIG. 12A, the system may do this by generating a mesh for the avatar 1202 and a mesh for the shadow 1203, and positioning the shadow mesh 1203 below the avatar mesh 1202. As illustrated in FIG. 12B, the system will complete the avatar 1207 by filling the avatar mesh with one or more solid colors, and the system will complete the shadow 1277 by filling some, but not all, pixels of the shadow mesh with a shading, thus giving the shadow 1277 a translucent appearance over the background in which it appears. As the user moves the avatar through the virtual environment, the shadow will follow the avatar on the display. Other methods of generating and rendering a shadow are possible, such as by generating an invisible “floor” that the avatar moves along and using the floor to render a shadow under the avatar’s position on the display.

In addition, in some embodiments the system may transform a two-dimensional (2D) image (whether a single image or one or more images from a video) to a three-dimensional (3D) audio plane in which the avatar may move in x-y-z directions. This is illustrated by way of example in FIGS. 11A-D. FIG. 11A shows a 2D image of the virtual environment 1101. The system will identify visual elements in the image that depict distinct sound emitting bodies 1113a … 1113h, such as people or musical instruments. The system may do this using any suitable identification method, including receipt of identifiers via a user interface, via by processing the image with edge detection and/or other image processing algorithms, by submitting the image to a machine learning model that has been trained to identify and label sources of sound in images, or by other techniques. The system may transform the 2D spatial arrangement of the sound emitting bodies 1113a … 1113h to a 3D navigation plane by generating an audio source for each sound emitting body and assigning x, y, and z coordinates to each audio source based on the location in the 2D image of the corresponding sound emitting body in the image compared to the locations of the other sound emitting bodies. In this method the system then uses the 2D image as a visual map of a virtual audio environment, as it identifies visual elements in the image that correspond to distinct audio sources. The 3D navigation plane can then serve as an audio plane in which the spatial audio zones are defined, and along which the avatar may move through the various spatial audio zones.

In FIG. 11B, the system renders such an audio plane 1112. Typically, audio plane 1112 may not be shown in the user interface, but the system will use it to locate the spatial audio zones in the image. In FIG. 11C, the system generates a unique audio source 1103a … 1103h, each of which corresponds to one of the sound emitting bodies (e.g., musical instruments) in the image or video. FIG. 11C illustrates a different perspective of the audio plane 1112 to show the positions of the various audio sources 1103a … 1103h on the audio plane 1112. The system will also position the spatial audio zones that it generates in this plane. Methods of defining the spatial audio zones are described above.

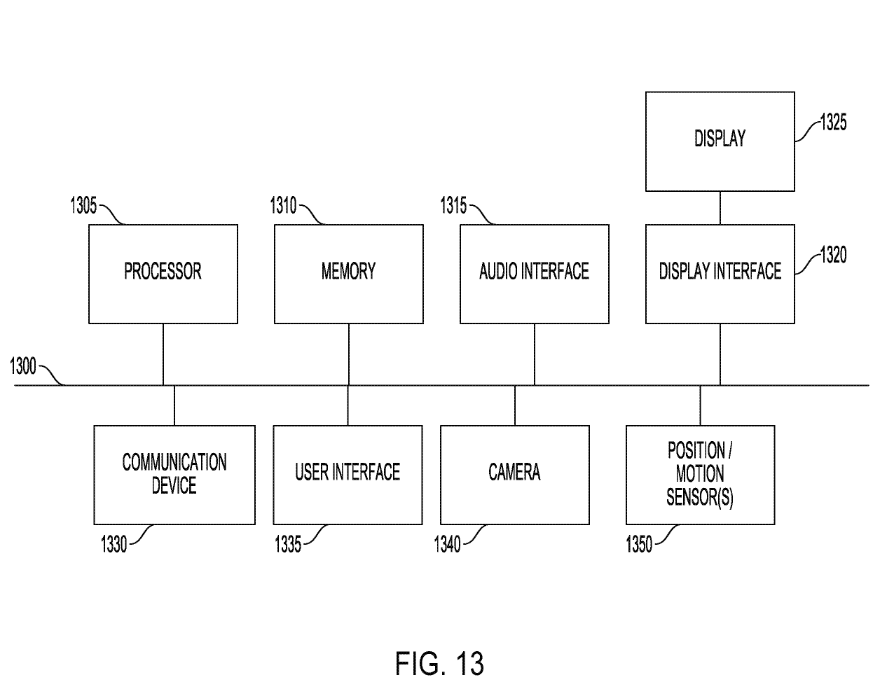

FIG. 13 depicts an example of hardware that may be included in any of the electronic components of the system, such as a smartphone, a tablet computing device, or a local or remote computing device in the system. A conductive path such as a bus 1300 serves as a communication path via which messages, instructions, data, or other information may be shared among the other illustrated components of the hardware. Processor 1305 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 1310. A memory device may include a single device or a collection of devices across which data and/or instructions are stored.

An optional display interface 1320 may enable information to be displayed on a display device 1325 in visual, graphic or alphanumeric format. An audio interface 1315 with audio output (such as a speaker) also may be provided. Communication with external devices may occur using various communication devices 1330 such as a wireless antenna, a radio frequency identification (RFID) tag and/or short-range or near-field communication transceiver, each of which may optionally communicatively connect with other components of the device via one or more communication systems. The communication device 1330 may be configured to be communicatively connected to a communications network, such as the Internet, a local area network or a cellular telephone data network.

The hardware may also include a user interface device 1335 that includes one or more input devices that can receive data and/or commands from a user. Example user interface devices 1335 include a keyboard, a mouse, touchscreen, a touch pad, a remote control, a pointing device, and/or a microphone. A camera 1340 may include image sensors and other hardware that can capture video and/or still images. The system also may include one or more positional and/or motion sensors 1350 that can detect position and movement of the device. Examples of motion sensors include gyroscopes, accelerometers, and inertial measurement units (IMUs). Examples of positional sensors include a global positioning system (GPS) sensor device that receives positional data from an external GPS network.

The following paragraphs provide additional information about various terms used in this document:

In this document, when terms such as “first” and “second” are used to modify a noun, such use is simply intended to distinguish one item from another and is not intended to require a sequential order unless specifically stated.

The term “approximately” when used in connection with a numeric value, is intended to include values that are close to, but not exactly, the number. For example, in some embodiments, the term “approximately” may include values that are within +/- 10 percent (or, in some embodiments, +/- 5 percent, +/- 3 precent, or +/1 percent) of the value.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual or augmented reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 13.

The terms “processor” and “controller” refer to electronic device hardware that is configured to execute programming instructions. The terms “processor” and “controller” may refer to either a single processor or controller, or to multiple processors or controllers that together implement various steps of a process. Unless the context specifically states that a single processor or controller is required or that multiple processors or controllers are required, the terms “processor” and “controller” include both the singular and plural embodiments.

The terms “memory,” “memory device,” “computer-readable medium” and “data store” each refer to a non-transitory device on which computer-readable data, programming instructions or both are stored. A “computer program product” combination of a memory device and the programming instructions stored in it. Unless the context specifically states that a single device is required or that multiple devices are required, the terms defined in this paragraph include both the singular and plural embodiments, as well as portions of such devices such as memory sectors.

The phrase “machine learning model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems perform various types of statistical analyses, machine learning systems are distinguished from statistical analyses by virtue of the ability to learn without explicit programming and being rooted in computer technology.

“Training” of a machine learning model may include building and/or updating a machine learning model from a sample dataset (referred to as a “training set”), evaluating the model against one or more additional sample datasets (referred to as a “validation set” and/or a “test set”) to decide whether to keep the model and to benchmark how good the model is, and using the model in a production environment to make predictions or decisions, or to generate content, based on new input data.

The features and functions described above, as well as alternatives, may be combined into many other different systems or applications. Various alternatives, modifications, variations or improvements may be made by those skilled in the art, each of which is also intended to be encompassed by the disclosed embodiments.

As described above, this document discloses system, method, and computer program product embodiments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

### Example embodiments are further illustrated by the following clauses:

Clause 1: A method of generating and presenting an audio-visual experience, the method comprising, by a processor, executing programming instructions that will cause the processor to: (a) identify a plurality of audio sources and, for each of the audio sources, a position of the audio source in a virtual environment; (b) for each of the plurality of audio sources, identify an audio track for the audio source; and (c) in response to receiving, via a user interface, a position of an avatar in the virtual environment: (i) for each one or more of the audio tracks, determine an enhancement level or an attenuation level for the audio track based on (a) a distance in the virtual environment of the avatar to the audio source for the audio track and/or (b) an orientation of the avatar in the virtual environment with respect to the audio source, and (ii) apply, to the audio tracks, its enhancement level or attenuation level, and (ii) cause an audio output of an electronic device to concurrently output each of the one or more audio tracks with its enhancement level or attenuation level.

Clause 2: The method of clause 1, further comprising, for one or more of the audio tracks: (a) determining a channel-specific enhancement level or channel-specific attenuation level for the audio track based on a relative position of the avatar with respect to the position of the audio source; and (b) when applying the determined enhancement levels or attenuation levels to the one or more of the audio tracks, also applying the channel-specific enhancement levels or channel-specific attenuation levels to the one or more of the audio tracks.

Clause 3: The method of clause 2, wherein applying the channel-specific enhancement levels or channel-specific attenuation levels to the one or more audio tracks comprises causing a volume of a first one of the audio tracks to be greater in a first of two channels of the audio outputs than it is in a second of the two channels of the audio outputs, wherein the first of the two channels corresponds to a relative position of the audio source for the first one of the audio tracks with respect to the position of the avatar in the virtual environment.

Clause 4: The method of any of clauses 1-3, further comprising modifying the enhancement level or the attenuation level for one or more of the audio tracks in response to receiving, via a user interface of the electronic device, a new position for the avatar in the virtual environment.

Clause 5: The method of any of clauses 1-4, wherein: (a) determining an enhancement level or an attenuation level for each audio track comprises identifying an attenuation curve for the audio source that is associated with that audio track; and (b) applying the determined enhancement level or attenuation level to that audio track comprises referring to attenuation curve to select an attenuation level to apply to the audio track based on the distance of the avatar to that audio source.

Clause 6: The method of any of clauses 1-5, further comprising, by the processor: (a) generating a graphic enhancement based on the position of the avatar in the virtual environment; and (b) causing a display of the electronic device to output a visual representation of the graphic enhancement.

Clause 7: The method of clause 6, wherein generating the graphic enhancement comprises displaying the graphic enhancement with a particular audio source in response to the avatar moving to a position that is proximate to or that touches the particular audio source.

Clause 8: The method of any of clauses 1-7, further comprising associating a unique audio zone with each of the audio sources in the virtual environment, wherein each audio zone comprises a region in the virtual environment for which the audio output will output audio emitted by the associated audio source when the avatar is positioned in that audio zone.

Clause 9: The method of clause 8, wherein at least some of the audio zones overlap to provide one or more areas in the virtual environment in which the processor will cause the audio output to output audio for the audio sources associated with the overlapping audio zones when the avatar is positioned in an associated area of overlap.

Clause 10: The method of clause 8, further comprising: (a) receiving a new location for one or more of the audio sources; and (b) for each of the audio sources for which a new location is received, updating a location of the audio zone that is associated with that audio source to correspond to the new location of that audio source.

Clause 11: The method of any of clauses 1-10, further comprising: (a) identifying, in a two-dimensional (2D) image, a plurality of sound emitting bodies; (b) transforming the 2D image into a three-dimensional (3D) audio navigation plane by assigning x, y, and z coordinates to each of the audio sources based on comparative locations of corresponding sound emitting bodies in the 2D image; and (c) enabling movement of the avatar within the 3D audio navigation plane such that the audio enhancement level and the attenuation level in the audio output will change based on the avatar’s location in the 3D audio navigation plane.

Clause 12: The method of any of clauses 1-11, further comprising: (a) causing a display device of the electronic device to output an image of the virtual environment, wherein the image includes the avatar at a location of the avatar in the virtual environment; (b) generating and displaying a translucent shadow with the avatar; and (c) causing the shadow to move with the avatar as the avatar is moved to other locations in the virtual environment.

Clause 13: A system comprising: (a) a processor; (b) a user interface; (c) an audio output; and (d) a memory containing programming instructions that will, when executed, cause the processor to implement a method according to any of clauses 1-12.

Clause 14: A computer program product comprising a memory device containing programming instructions that will, when executed, cause a processor to implement a method according to any of clauses 1-12.

1. A method of generating and presenting an audio-visual experience, the method comprising, by a processor, executing programming instructions that will cause the processor to:
identify a plurality of audio sources and, for each of the audio sources, a position of the audio source in a virtual environment;
for each of the plurality of audio sources, identify an audio track for the audio source; and
in response to receiving, via a user interface, a position of an avatar in the virtual environment:
for each of one or more of the audio tracks:
determine an enhancement level or an attenuation level for the audio track based on a distance in the virtual environment of the avatar to the audio source for the audio track, and
apply, to the audio track, its enhancement level or attenuation level, and
cause an audio output of an electronic device to concurrently output each of the one or more audio tracks with its enhancement level or attenuation level.

2. The method of claim 1, further comprising:
for one or more of the audio tracks, determining a channel-specific enhancement level or channel-specific attenuation level for the audio track based on a relative position of the avatar with respect to the position of the audio source; and
when applying the determined enhancement levels or attenuation levels to the one or more of the audio tracks, also applying the channel-specific enhancement levels or channel-specific attenuation levels to the one or more of the audio tracks.

3. The method of claim 2, wherein applying the channel-specific enhancement levels or channel-specific attenuation levels to the one or more audio tracks comprises:
causing a volume of a first one of the audio tracks to be greater in a first of two channels of the audio outputs than it is in a second of the two channels of the audio outputs,
wherein the first of the two channels corresponds to a relative position of the audio source for the first one of the audio tracks with respect to the position of the avatar in the virtual environment.

4. The method of claim 1, further comprising modifying the enhancement level or the attenuation level for one or more of the audio tracks in response to receiving, via a user interface of the electronic device, a new position for the avatar in the virtual environment.

5. The method of claim 1, wherein:
determining an enhancement level or an attenuation level for each audio track comprises identifying an attenuation curve for the audio source that is associated with that audio track; and
applying the determined enhancement level or attenuation level to that audio track comprises referring to attenuation curve to select an attenuation level to apply to the audio track based on the distance of the avatar to that audio source.

6. The method of claim 1, further comprising, by the processor:
generating a graphic enhancement based on the position of the avatar in the virtual environment; and
causing a display of the electronic device to output a visual representation of the graphic enhancement.

7. The method of claim 6, wherein generating the graphic enhancement comprises displaying the graphic enhancement with a particular audio source in response to the avatar moving to a position that is proximate to or that touches the particular audio source.

8. The method of claim 1, further comprising:
associating a unique audio zone with each of the audio sources in the virtual environment,
wherein each audio zone comprises a region in the virtual environment for which the audio output will output audio emitted by the associated audio source when the avatar is positioned in that audio zone.

9. The method of claim 8, wherein at least some of the audio zones overlap to provide one or more areas in the virtual environment in which the processor will cause the audio output to output audio for the audio sources associated with the overlapping audio zones when the avatar is positioned in an associated area of overlap.

10. The method of claim 8, further comprising:
receiving a new location for one or more of the audio sources; and
for each of the audio sources for which a new location is received, updating a location of the audio zone that is associated with that audio source to correspond to the new location of that audio source.

11. The method of claim 1, further comprising:
identifying, in a two-dimensional (2D) image, a plurality of sound emitting bodies;
transforming the 2D image into a three-dimensional (3D) audio navigation plane by assigning x, y, and z coordinates to each of the audio sources based on comparative locations of corresponding sound emitting bodies in the 2D image; and
enabling movement of the avatar within the 3D audio navigation plane such that the audio enhancement level and the attenuation level in the audio output will change based on the avatar’s location in the 3D audio navigation plane.

12. The method of claim 1, further comprising:
causing a display device of the electronic device to output an image of the virtual environment, wherein the image includes the avatar at a location of the avatar in the virtual environment;
generating and displaying a translucent shadow with the avatar; and
causing the shadow to move with the avatar as the avatar is moved to other locations in the virtual environment.

13. The method of claim 1, wherein determining the enhancement level or the attenuation level for the audio track is also based on an orientation of the avatar in the virtual environment relative to the audio source for the audio track.

14. A computer program product comprising a memory device containing programming instructions that, when executed, will cause a processor to:
identify a plurality of audio sources and, for each of the audio sources, a position of the audio source in a virtual environment;
for each of the audio sources, identify an audio track for the audio source, and
in response to receiving, via a user interface, a position of an avatar in the virtual environment:
for each of one or more of the audio tracks:
determine an enhancement level or an attenuation level for the audio track based on one or more of the following:
a distance in the virtual environment of the avatar to the audio source for the audio track, or
an orientation of the avatar in the virtual environment relative to the audio source for the audio track, and
apply, to the audio track, its determined enhancement level or attenuation level, and
cause an audio output of an electronic device to concurrently output each of the one or more audio tracks with its applied enhancement level or attenuation level.

15. The computer program product of claim 14, wherein the programming instructions are further configured to cause the processor to:
for one or more of the audio tracks, determine a channel-specific enhancement level or channel-specific attenuation level for the audio track based on a relative position of the avatar with respect to the position of the audio source; and
when applying the determined enhancement levels or attenuation levels to the one or more of the audio tracks, also apply the channel-specific enhancement levels or channel-specific attenuation levels to the one or more of the audio tracks.

16. The computer program product of claim 14, wherein the programming instructions are further configured to cause the processor to:
in response to receiving, via a user interface of the electronic device, a new position for the avatar in the virtual environment, modify the enhancement level or the attenuation level for one or more of the audio tracks.

17. The computer program product of claim 14, wherein the programming instructions are further configured to cause the processor to:
generate a graphic enhancement based on the position of the avatar in the virtual environment; and
cause a display of the electronic device to output a visual representation of the graphic enhancement.

18. The computer program product of claim 14, wherein the programming instructions are further configured to cause the processor to:
associate a unique audio zone with each of the audio sources in the virtual environment,
wherein each audio zone comprises a region in the virtual environment for which the audio output will output audio emitted by the associated audio source when the avatar is positioned in that audio zone.

19. The computer program product of claim 14, wherein the programming instructions are further configured to cause the processor to:
identify, in a two-dimensional (2D) image, a plurality of sound emitting bodies;
transform the 2D image into a three-dimensional (3D) audio navigation plane by assigning x, y, and z coordinates to each of the audio sources based on comparative locations of corresponding sound emitting bodies in the 2D image; and
enable movement of the avatar within the 3D audio navigation plane such that the audio enhancement level and the attenuation level in the audio output will change based on the avatar’s location in the 3D audio navigation plane.

20. The computer program product of claim 14, wherein the programming instructions are further configured to cause the processor to:
cause a display device of the electronic device to output an image of the virtual environment, wherein the image includes the avatar at a location of the avatar in the virtual environment;
generate and display a translucent shadow with the avatar; and
cause the shadow to move with the avatar as the avatar is moved to other locations in the virtual environment.

21. A system comprising:
a processor;
a user interface;
an audio output; and
a memory containing programming instructions that will, when executed, cause the processor to:
identify a plurality of audio sources and, for each of the audio sources, a position of the audio source in a virtual environment,
for each of the audio sources, identify an audio track for the audio source, and
in response to receiving, via the user interface, a position of an avatar in the virtual environment:
for each of one or more of the audio tracks:
determine an enhancement level or an attenuation level for the audio track based on one or more of the following:
a distance in the virtual environment of the avatar to the audio source for the audio track, or
an orientation of the avatar in the virtual environment relative to the audio source for the audio track, and
apply, to the audio track, its determined enhancement level or attenuation level; and
cause the audio output to concurrently output each of the one or more audio tracks with its applied enhancement level or attenuation level.
